(19) United States
(12) Patent Application Publication
(10) Pub. No.: US 2024/0362261 A1
(43) Pub. Date: Oct. 31, 2024

(54) Interpreting Natural Language Comparisons During Visual Analysis

(71) Applicant: Salesforce, Inc., San Francisco, CA (US)

(72) Inventor: Vidya Raghavan SETLUR, Portola Valley, CA (US)

(21) Appl. No.: 18/651,605

(22) Filed: Apr. 30, 2024

Related U.S. Application Data
(60) Provisional application No. 63/463,057, filed on Apr. 30, 2023.

(51) Int. Cl. G06F 16/34; G06F 3/04812; G06F 3/0482; G06F 16/332

(52) U.S. Cl. CPC G06F 16/345; G06F 3/04812; G06F 3/0482; G06F 16/3329

(57) ABSTRACT

System, method and interface for interpreting natural language comparisons during visual analysis are provided. The system includes obtaining a natural language utterance that includes a comparison query and a dataset of attributes and values relevant to interpreting the comparison query. The system also includes interpreting the natural language utterance based on the dataset using multi-step chain-of-thought reasoning prompting to generate a response to the comparison query. The system also includes generating a visualization based on the response and a text summary describing the multi-step chain-of-thought reasoning for the comparison query.

### RELATED APPLICATIONS

This application claims priority to U.S. Provisional Application Ser. No. 63/463,057, filed Apr. 30, 2023, entitled “Interface for Interpreting Natural Language Comparisons During Visual Analysis,” which is incorporated by reference herein in its entirety.

### TECHNICAL FIELD

The disclosed implementations relate generally to data visualization and more specifically to systems, methods, and user interfaces that enable users to interact with and explore datasets using a conversational interface.

### BACKGROUND

Natural language interfaces for visual analysis allow users to interact with visual data using natural language for a wide range of tasks, including data visualization and analysis. Conventional systems use parsers to interpret natural language utterances to provide relevant visualization responses to help people complete analytic tasks, such as visual comparisons of data entities and values. The analytical process of interpreting comparisons during visual analysis can be complex. There are several ways to support interpretation of comparisons. This process often involves synthesizing information about the data entities and values being compared, the various parameters that indicate what is being compared, and how that information is represented in a visualization response. These comparison tasks often involve discerning common patterns, differences, and trends in the data, such as, “show me the top performing sales accounts.” The semantic analysis of these comparatives involves the interpretation of superlatives and gradable predicates, which makes use of abstract representations of measurement, formalized as sets of objects ordered with respect to some dimension. Despite advancements in natural language interfaces, interpreting and providing analytical responses for natural language comparisons continues to be a challenge. The language for expressing comparisons is often ambiguous or vague, making it difficult to convey precise comparisons without leaving room for multiple interpretations. Additionally, natural language comparisons often involve subjective judgments, which can lead to varying interpretations and opinions among users.

### SUMMARY

Accordingly, there is a need for systems, methods and interfaces for interpreting natural language (NL) comparisons using visual analysis. Some implementations identify an interactive design space of NL comparison utterances covering various categories of comparisons along with their interaction behaviors and affordances. Some implementations provide an interactive interface that supports the interpretation of NL comparison utterances. Some implementations use a machine-learning (ML) query parser that interprets the comparison utterances to generate a relevant visualization response. The underlying data used to render the visualization is then input as a prompt to a large language model to generate a summary describing the comparison. Some implementations use a multi-step chain-of-thought reasoning prompting algorithm for interpreting a comparison utterance. In some implementations, the interface also provides affordances to the user to modify the visualization response for the comparison query, along with entities inferred for ambiguous utterances.

According to some implementations, a method is provided for interpreting natural language comparisons during visual analysis of a dataset, according to some implementations. The method is performed at a computing system having one or more processors and memory storing one or more programs configured for execution by the one or more processors. The method includes obtaining a natural language utterance that includes a comparison query and a dataset of attributes and values relevant to interpreting the comparison query. The method also includes interpreting the natural language utterance based on the dataset using multi-step chain-of-thought reasoning prompting to generate a response to the comparison query. The method also includes generating a visualization based on the response and a text summary describing the multi-step chain-of-thought reasoning for the comparison query.

In some implementations, the multi-step chain-of-thought reasoning prompting includes identifying relevant attributes and values by inputting a prompt containing the comparison query and a representation of the dataset to a trained large language model.

In some implementations, the multi-step chain-of-thought reasoning prompting further includes inferring cardinality and concreteness of the comparison query by inputting another prompt containing the comparison query, the representation of the dataset and the relevant attributes and values to the trained large language model.

In some implementations, the multi-step chain-of-thought reasoning prompting further includes: inferring a comparative analysis response by inputting yet another prompt containing the comparison query, the representation of the dataset, the relevant attributes and values, and the cardinality and concreteness, to the trained large language model; and executing a query to the dataset based on the comparative analysis response to retrieve the response to the comparison query.

In some implementations, generating the text summary describing the multi-step chain-of-though reasoning includes inputting prompts used for the multi-step chain-of-though reasoning and any output obtained therefrom to a trained large language model to obtain a text output summarizing process, input and intermediate output.

In some implementations, generating the visualization includes generating a default visualization based on a most common canonical visualization for a cardinality obtained via the multi-step chain-of-thought reasoning for the comparison query.

In some implementations, the method further includes providing one or more affordances in a graphical user interface used for displaying the visualization, the one or more affordances allowing a user to repair or refine the interpretation of ambiguous tokens or switch to an alternative visualization.

In some implementations, the method further includes: providing, in a graphical user interface used for displaying the visualization, a drop-down menu of attributes sorted by a probability for a token computed by the multi-step chain-of-thought reasoning prompting; and in response to a user selecting an attribute, updating an intermediate prompt used for the multi-step chain-of-thought reasoning prompting and/or updating the visualization based on the attribute.

In some implementations, the method further includes: providing, in a graphical user interface used for displaying the visualization, a drop-down menu of graph plot types; and in response to a user selecting a graph plot type, updating the visualization to use the graph plot type.

In some implementations, the method further includes: showing a landing screen, in a graphical user interface used for displaying the visualization, the landing screen displaying a table containing metadata for the dataset in a data panel; in response to detecting a user input hovering over a data source thumbnail, allowing the user to view its corresponding metadata information; and detecting the natural language utterance via the graphical user interface.

In some implementations, generating the visualization includes generating (i) unit charts for 1-1 comparisons between two items, (ii) bar charts for 1-n comparisons between one item and another set of multiple items (1-n comparisons), (iii) scatterplots for n comparisons between multiple items, and (iv) dot plots support n-m comparisons between two sets.

According to some implementations, a method is provided for interpreting natural language comparisons during visual analysis of a dataset, according to some implementations. The method is performed at a computing system having one or more processors and memory storing one or more programs configured for execution by the one or more processors. The method includes displaying a landing screen that includes a table containing metadata for a dataset selected in a data panel. The method also includes, in response to detecting a user input that corresponds to a natural language utterance, interpreting and classifying the natural language utterance based on cardinality and concreteness using a parser that is trained using a conversational artificial intelligence library. The method also includes generating a visualization that includes a plurality of encoding channels and a plurality of mark types along with custom marks for displaying symbols in unit charts. The method also includes displaying a dynamic text summary describing the visualization by inputting, to a large language model, a prompt containing a data snapshot of data attributes and values relevant to interpreting the comparison utterance. The method also includes providing affordances for a user to change the default system choices, including repairing and refining (i) interpretation of ambiguous tokens and (ii) switching to an alternative visualization.

In some implementations, the parser is trained using templated examples of crowdsourced utterances and comparison utterances.

In some implementations, the templates include slots for attributes and values.

In some implementations, a set of data sources is specified during the training of the parser.

In some implementations, the parser handles imprecision including misspellings and incomplete input by applying fuzzy matching and lammatization on input tokens with attributes in the datasets

In some implementations, the method further includes augmenting the datasets with additional metadata and semantics that helps with understanding and interpretation of the utterances, such as related ontological concepts, including synonyms and related terms.

In some implementations, the marks and encodings support dynamic generation of bar charts, line charts, scatterplots, dot plots, box plots, and unit charts that cover the range of comparisons.

In some implementations, generating the visualization includes selecting a default visualization based on common canonical visualization for the corresponding cardinality.

In another aspect, an electronic device includes one or more processors, memory, a display, and one or more programs stored in the memory. The programs are configured for execution by the one or more processors and are configured to perform any of the methods described herein.

In another aspect, a non-transitory computer readable storage medium stores one or more programs configured for execution by a computing device having one or more processors, memory, and a display. The one or more programs are configured to perform any of the methods described herein.

Thus methods, systems, and graphical user interfaces are disclosed that allow users to perform visual analysis of datasets.

Both the foregoing general description and the following detailed description are exemplary and explanatory and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Description of Implementations below, in conjunction with the following drawings in which like reference numerals refer to corresponding parts throughout the figures.

FIGS. 1A-1D illustrate a graphical user interface for supporting natural language comparisons of different cardinalities and correctness, according to some implementations.

FIGS. 2A and 2B illustrate a graphical user interface for supporting interactions during visual analysis, according to some implementations.

FIG. 3 shows an example landing page for visual analysis of datasets using natural language comparisons, according to some implementations.

FIG. 4 is a block diagram illustrating a computing device, which can display the graphical user interfaces and support visual analysis of datasets, in accordance with some implementations.

FIG. 5 provides a flowchart of a process for interpreting natural language comparisons during visual analysis of a dataset, according to some implementations.

FIG. 6 provides a flowchart of a process for interpreting natural language comparisons during visual analysis of a dataset, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

As described above in the Background section, the analytical process of interpreting comparisons during visual analysis can be complex, with several ways to support their interpretation. This process often involves synthesizing information about the data entities and values being compared, the various parameters that indicate what is being compared, and how that information is represented in a visualization response. To this end, some implementations provide an interface that supports comparisons expressed in natural language (NL) in a visual analytical workflow. Described herein are different types of comparisons and interactive designs for supporting the interpretation of comparisons in a natural language interface context, according to some implementations.

### Examples of Types of Comparisons

A design space for visual comparisons may be defined based on empirical data, which is structured by the cardinality and concreteness of comparisons. For the cardinality, a comparison involves identifying the relationship between two or more entities and are categorized into four types:
One-to-One (1:1) Comparisons: Comparison of two individual items, such as “Compare the budget of Jaws and Safe House.”
One-to-Many (1:n) Comparisons: Comparison between one item and another set of multiple items, such as “Compare the budget of Intrusion to all other thriller movies.”
Comparisons between Multiple Items within the Same Set (n): Comparison between multiple items within the same set, such as “Compare the budget across all TV shows.”
Many-to-Many (n:m) Comparisons: Comparison between one set of items to another set, such as “Compare the ratings of comedies to thrillers.”

In some implementations, concreteness refers to the spectrum of comparisons that are implicitly or explicitly defined. A comparison is less concrete when it does not explicitly reference a data attribute or value. For example, given a movie dataset with attributes ‘Box office’ and ‘User rating’, an implicit comparison asking about a movie's ‘popularity’ is related but not explicitly mapped to either of the two attributes. A more concrete comparison could be “compare box office numbers of action movies.”

In terms of visualizations supporting these comparisons, for 1-1 comparisons, some implementations use bar charts and unit charts. For 1-n comparisons, some implementations use bar charts and scatter plots. For n comparisons, bar charts, box plots, and scatter plots are used, according to some implementations. In some implementations, for n-m comparisons, bar charts and scatter plots are used. To implement these comparisons in the context of an natural language interface, some implementations determine interactivity preferences.

An experimental study interviewed sixteen visualization experts and novices, asking them to sketch visualization(s) that would best answer comparisons across different cardinalities and concreteness. Data was collected and reviewed to identify the interactivity opportunities. The interactions in the data were coded along with examples from the coding exercise, based on the following categories of interaction techniques:
Select technique allows the user to mark data points that are interesting with a different color, for example, so that the user can keep track of the marked data point that is being compared.
Elaborate technique provides the ability to view data details on demand. For example, adding tooltips in a visualization allows the user to look at more information.
Explore allows users to examine data to gain a better under-standing and insight. One example is displaying a metadata summary in the interface to view details of the dataset.
Filter allows the user to change and adjust the set of data items being presented at a time based on a specific condition. For example, sliders and drop-down menus allow users to constrain or switch to a different data value.
Repair and Refinement: An additional category where participants indicated that the need for affordances to modify the inferred attributes for ambiguous terms and the ability to switch to an alternative visualization based on user preference.

### Example Design Guidelines

The above observations helped distill a list of design guidelines that helped inform the implementation of the system described herein, according to some implementations. These are example design principles and a different set (e.g., a subset, a superset) of design guidelines may be used in different implementations.
DG1: Support comparisons with all four cardinalities: The system supports and interprets NL utterances for all four cardinalities with varying levels of concreteness.
DG2: Support interactivity: The system is interactive and allows the user to interact with the visualizations, especially when there is ambiguity involved in the comparison.
DG3: Provide a text summary describing the comparison: The system summarizes the main findings from the visualization in NL textual description.
DG4: Provide useful visualization responses: The system shows a default visualization and then also allows the user to switch between different visualizations that support the same comparison to be viewed in a different visual setting.
DG5: Provide affordances for repair and refinement: The system allows the user to change the interpretation of implicit tokens via different forms of interactivity or change of visualization type.

### Example Interfaces

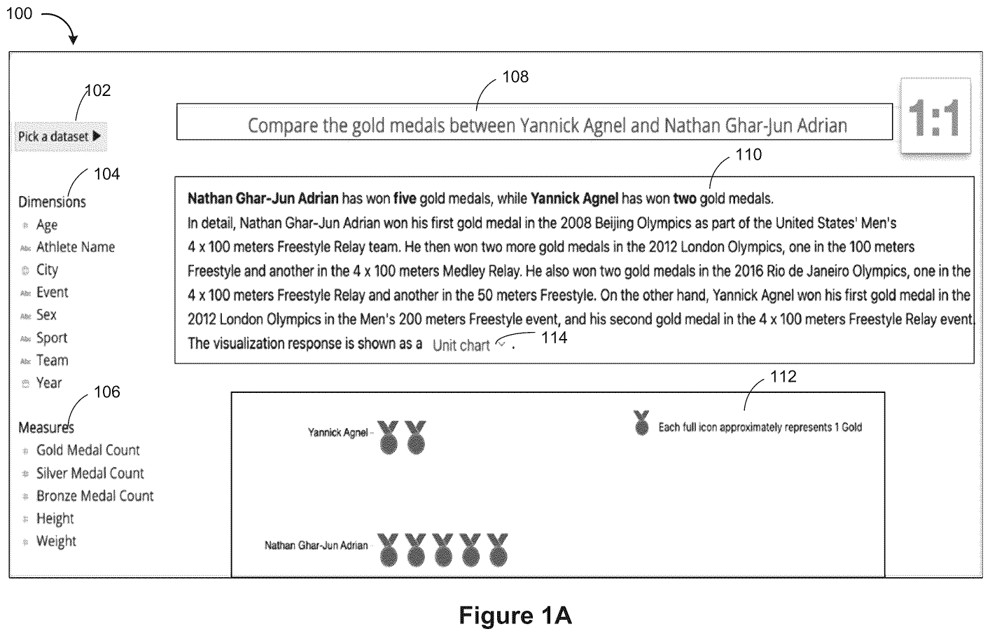

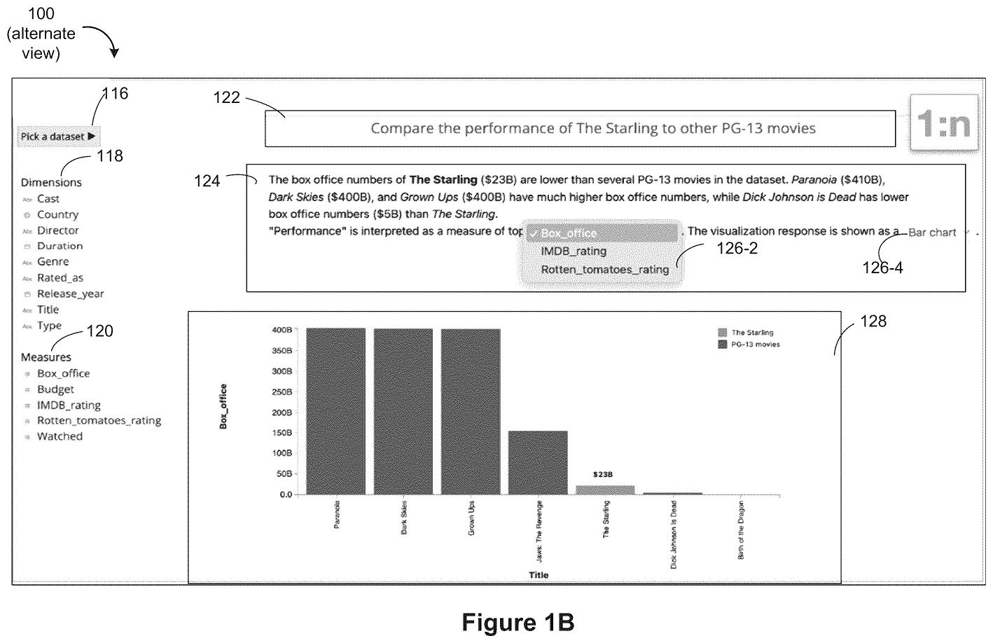

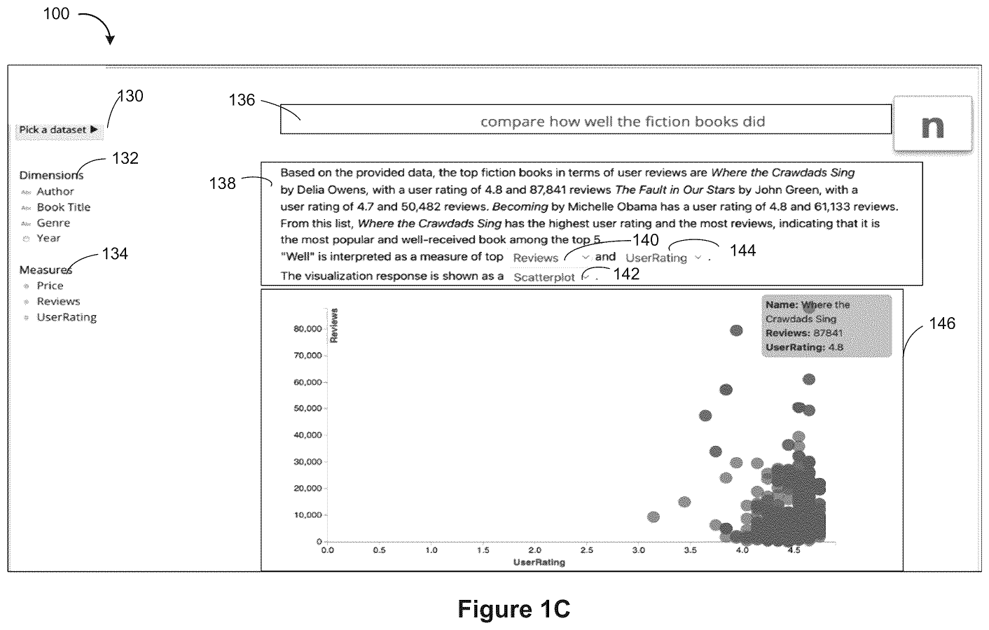

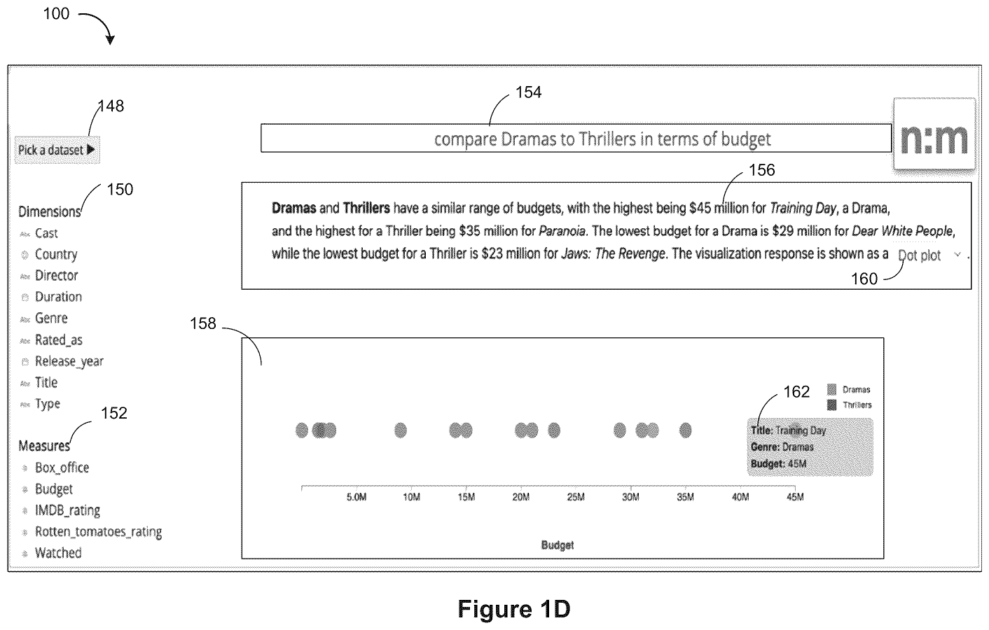

FIGS. 1A-1D illustrate a graphical user interface 100 for supporting natural language comparisons of different cardinalities and correctness, according to some implementations. In some implementations, the interface supports various cardinalities of data entities and values being compared along with the degree of concreteness (e.g., implicit or explicit mention of the parameters of the comparison utterances). In some implementations, the interface is similar to that of natural language interfaces for visual analysis with extensions to support the interpretation of comparison utterances.

FIG. 1A shows an example view for a 1:1 comparison, according to some implementations. The interface shows dimensions 104 and/or measures 106 for a dataset 102. Suppose the user enters a comparison utterance in a text box 108. Here, the utterance is “Compare the gold medals between Rannick Agnel and Nathan Ghar-Jun Adrian”), which is an example of a 1:1 comparison (described below). The system responds with a unit chart 112, and a text summary 110. One or more affordances 114 are provided for selecting a chart type for the visualization response.

FIG. 1B shows another example view for a 1:n comparison, according to some implementations. The interface shows dimensions 118 and/or measures 120 for a dataset 116. Suppose the user enters a comparison utterance in a text box 122. Here, the utterance is “Compare the performance of The Starling to other PG-13 movies,” which is an example of a 1:n comparison (described below). The system responds with a bar chart 128, and a text summary 124. One or more affordances 126-2 (e.g., a drop-down menu) are provided for selecting an interpretation for the “Performance” measure. One or more other affordances 126-4 are provided for selecting a chart type for the visualization response.

FIG. 1C shows another example view for an n comparison, according to some implementations. The interface shows dimensions 132 and/or measures 134 for a dataset 130. Suppose the user enters a comparison utterance in a text box 136. Here, the utterance is “compare how well the fiction books did,” which is an example of an n comparison (described below). The system responds with a scatter plot 146, and a text summary 136. One or more affordances 140 and 144 (e.g., drop-down menus) are provided for selecting an interpretation for the “Well” measure (e.g., for interpreting the term “Well based on top “reviews” and “user rating”). One or more other affordances 142 are provided for selecting a chart type for the visualization response.

FIG. 1D shows another example view for an nim comparison, according to some implementations. The interface shows dimensions 150 and/or measures 152 for a dataset 148. Suppose the user enters a comparison utterance in a text box 154. Here, the utterance is “compare Dramas to Thrillers in terms of budget,” which is an example of an n:m comparison (described below). The system responds with a dot plot 159, and a text summary 156. One or more affordances 160 are provided for selecting a chart type for the visualization response. The dot plot may highlight (e.g., show in a pop-up 162) details of any outliers or relevant dots/points in the plot that are responsive to the comparison utterance. Here, title, genre and budget are shown for Training Day, the Drama with the highest budget. As shown and described herein, unit charts are effective for 1-1 comparisons between two items, bar charts support comparisons between one item and another set of multiple items (1-n comparisons), scatterplots afford comparisons between multiple items (n comparisons), and dot plots support n-m comparisons between two sets. So these types of plots may be set as default charts or plots for the respective comparison types. The user may override the default charts/plots.

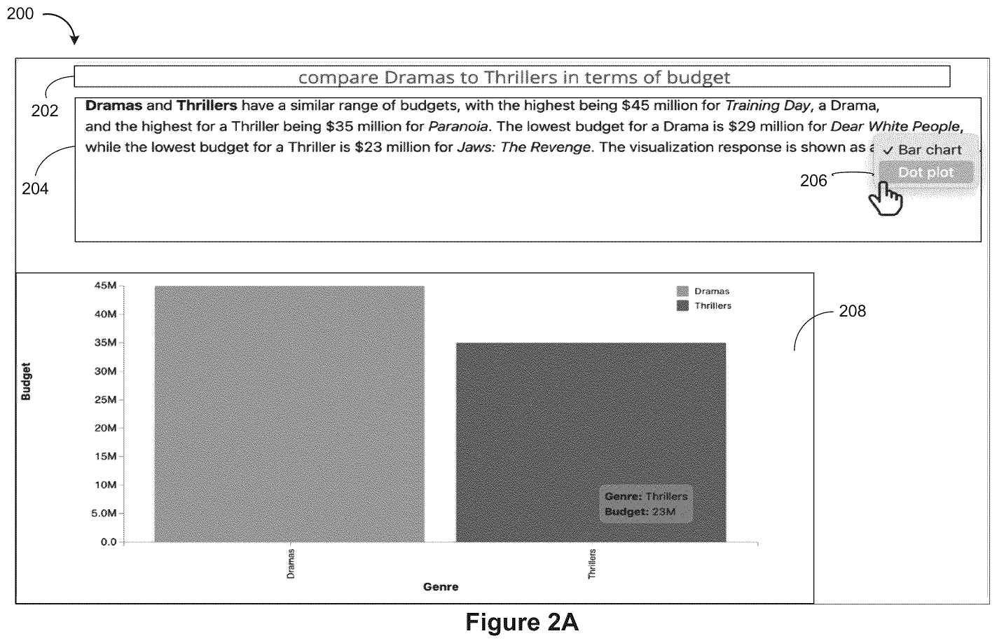

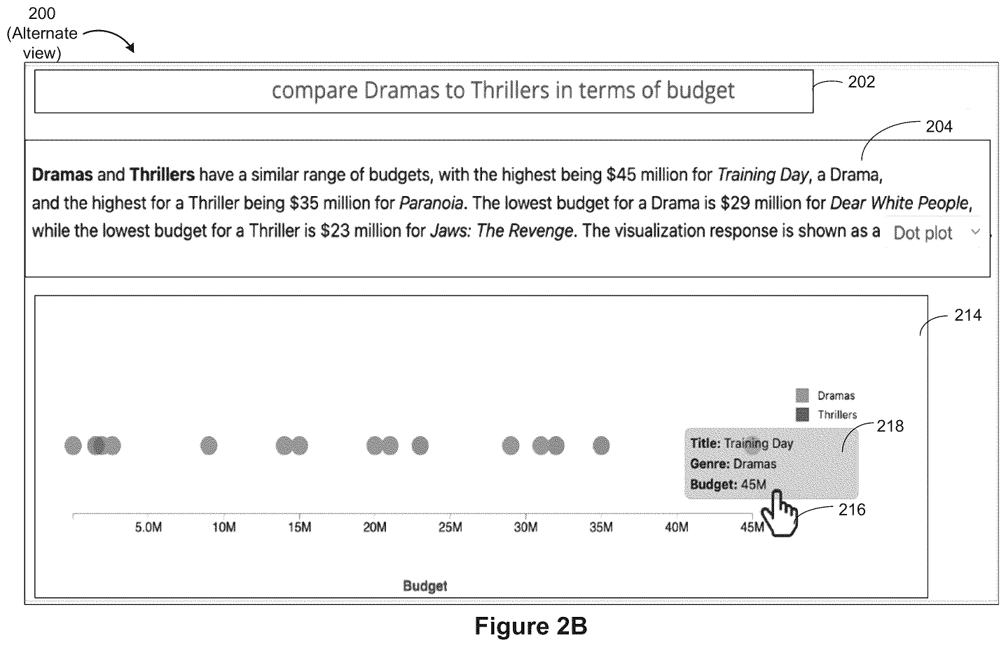

FIGS. 2A and 2B illustrate a graphical user interface 200 for supporting interactions during visual analysis, according to some implementations. Referring to FIG. 2A, after a user enters a text 202 (or speaks using a voice interface), the interface is updated to initially show a bar chart 208 for “Compare Dramas to Thrillers in terms of budget.” The user clicks the drop-down menu 206 to select an alternative chart type (dot plot in this case) for the n-m comparison. Referring next to FIG. 2B, the graph plot is updated to show a dot plot 214. The user hovers (216) to view details, in response to which the system shows the details 218. The generated text summary 204 adds additional context to how the comparisons are interpreted and enables interactive affordances to support repair and refinement.

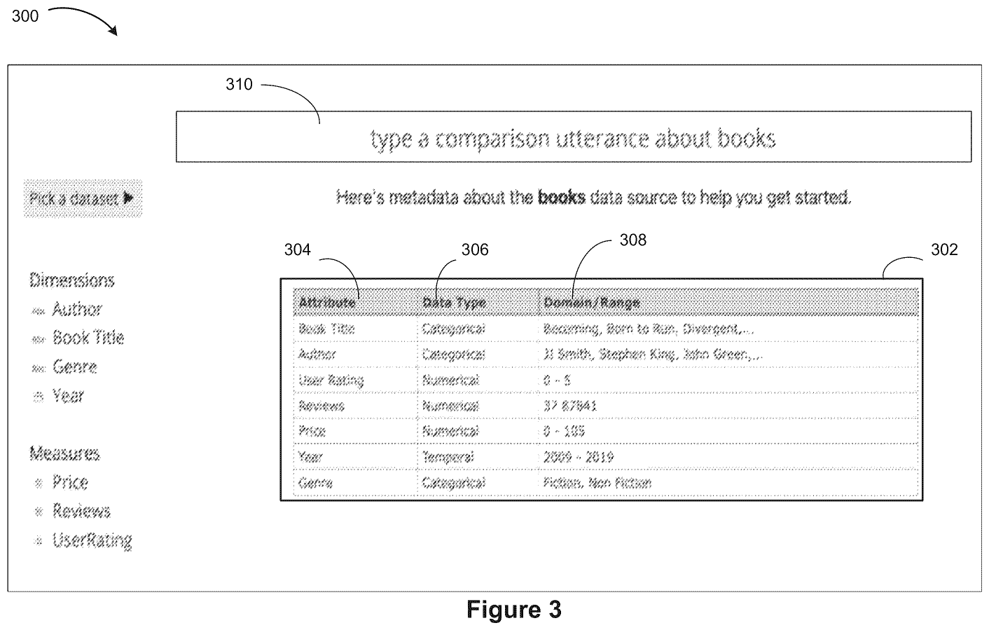

FIG. 3 shows an example landing page 300 for visual analysis of datasets using natural language comparisons, according to some implementations. In some implementations, the interface described herein may be based on natural language interfaces (NLIs) for visual analysis, with one or more features for interpreting comparison utterances. In some implementations, the interface initially shows a landing screen (sometimes referred to as a start page or a landing page) that displays a table 302 containing metadata for a chosen dataset in a data panel. The metadata may include attribute 304, data type 306, and/or domain range 308 for the dataset. In some implementations, a user can hover over a data source thumbnail and view its corresponding metadata information. In some implementations, typing an NL utterance (e.g., “compare the gold medals won by Rebecca Adlington to other athletes in Women's Swimming”) in an input text box and pressing the “enter” key invokes the system's interpretation of the comparison utterance.

In some implementations, the system is implemented as a web application that accepts any tabular CSV dataset as input and is developed using node.js, HTML/CSS, and JavaScript.

In some implementations, the visualization generation process supports a plurality of encoding channels (x, y, color) and four mark types (bar, line, point, circle), along with custom marks for displaying symbols in unit charts. These marks and encodings support the dynamic generation of bar charts, line charts, scatterplots, dot plots, box plots, and unit charts that cover the range of comparisons. Some implementations select the default visualization based on the most common canonical visualization for the corresponding cardinality. Some implementations display a dynamic text summary describing the generated visualization. In some implementations, visualizations are created using Vega-Lite, D3, other similar tools, software libraries, and/or programs.

### Example Chain-of-Thought (CoT) Reasoning for Query Interpretation

Some implementations use a CoT reasoning using a three-hop (where ‘hop’ refers to a step in a multi-step reasoning process) prompting algorithm (e.g., as performed by the parser or chain-of-thought reasoning module 440) for interpreting the input NL comparison utterance. In some implementations, the input to the module is a prompt containing the comparison utterance and the dataset of attributes and values relevant to interpreting the comparison utterance. The algorithm, in the first hop, identifies any specific aspects (e.g., attributes and values) in the comparison:

$$A = arg max p ( a \vert X , t ) \qquad ( 1 )$$

where A is the output text explicitly mentioning the aspect(s) of comparison for the input comparison, X (e.g., “Compare the performance of Starling with other PG-13 movies”), t represents the target entities involved in the comparison, and the function argmax computes the probability of each aspect a given X and t, selecting the aspect with the highest probability as A. A explicitly mentions the aspect(s), such as attributes Title and Rated_as that refer to ‘Starling’ and ‘PG-13’ respectively.

Based on the identified aspects, in some implementations, the CoT module is prompted to infer cardinality and concreteness in the second hop and is represented as:

$$I = arg max p ( i \vert X , t , a ) \qquad ( 2 )$$

where I includes inferred values i based on the aspect(s) identified in the first hop. In this example, Box_office, IMDB_rating, and Rotten_tomatoes_rating are attributes inferred for the token ‘performance’ in decreasing order of probability.

With the complete comparative framework (including the entities, aspects, cardinality, and concreteness), in some implementations, the CoT module is prompted to infer the final comparative analysis as follows:

$$C = arg max p ( y \vert X , t , a , i ) \qquad ( 3 )$$

In some implementations, the final output C provides the comparative analysis, executing a SQL query to the underlying data to retrieve results for Starling's performance relative to other PG-13 movies.

### Example Chain-of-Thought Prompts for Different Comparison Types

Described herein are example prompts for different comparison types, according to some embodiments.
One-to-One (1:1) Comparisons. To compare {Entity 1} and {Entity 2} on {Specific Attribute}, first gather data on {Specific Attribute} for both entities. Next, analyze and contrast these data points to identify trends, differences, or similarities. Conclude with an assessment of which entity performs better regarding {Specific Attribute}.
One-to-Many (1:n) Comparisons. Begin by collecting data on {Specific Attribute} for {Single Entity} and {Group of Entities}. Compare {Single Entity}'s data against the average or aggregate data of {Group of Entities}. Identify key differences and discuss the implications of these findings on {Single Entity}'s performance or status relative to the group.
Many-to-Many (n:m) Comparisons. First, obtain data for {Group of Entities 1} and {Group of Entities 2} regarding {Specific Attribute}. Analyze the data to compare and contrast the two groups' similarities and differences on {Specific Attribute}. Evaluate the overall trends and determine which group shows superior outcomes or characteristics based on the analysis.
Comparisons between Multiple Items within the Same Set(n). Collect data on {Specific Attribute} for all entities within {Set of Entities}. Analyze each entity's performance or status based on {Specific Attribute}. Summarize the data to identify the similarities and differences of entities within the set. Conclude with insights into the overall performance trends seen in the set.

### Example Parsing and Interpreting Utterances

Some implementations use a parser trained to classify and interpret the utterances based on cardinality and concreteness using an open-source conversational artificial intelligence (AI) library. In some implementations, the training set for the parser is a set of templated examples of crowdsourced utterances, along with comparison utterances. Templates may include slots for attributes and values, such as “Compare (value) with other (values) based on (measure)?” where ‘measure’ is a numerical attribute that can be aggregated (e.g., Budget, Rating). As part of training, a set of data sources may be specified over which the system operates. In some implementations, the parser handles imprecision, such as misspellings and incomplete input, by applying fuzzy matching and lemmatization on the input tokens with attributes in the datasets. Some implementations augment the datasets with additional metadata and semantics that helps the system's understanding and interpretation of the utterances, such as related ontological concepts, including synonyms (e.g., ‘film’ and ‘movie’) and related terms (e.g., ‘swimming,’ ‘freestyle,’ and ‘butterfly stroke’).

Some implementations use a design space of NL comparison utterances covering categories of comparisons along with their interaction behaviors and affordances. Informed by this design space, some implementations provide an interface that supports the interpretation of comparison utterances. In some implementations, the system uses a trained query parser that interprets the comparison utterances to generate a relevant visualization response. In some implementations, the data used to render the visualization is provided as a prompt to a large language model (e.g., ChatGPT) to generate a summary describing the comparison. In some implementations, the interface also provides affordances to the user to modify the visualization response and entities inferred for ambiguous utterances.

In some implementations, values in a dataset may undergo stemming, fuzzy matching, and/or fixes for misspelling or typographical errors, prior to, during or after the reasoning and/or the parsing steps described above. In some implementations, a schema of dataset, a modified comparison question, and/or attributes in comparison may be input to a large language model to obtain a ranked (e.g., decreasing) order of items that match the comparison utterance or question. In a second step, the output of the first step along with the initial input is input to the large language model to obtain cardinality and/or concreteness. And in a third step, relevant final output is generated based on the cardinality and/or concreteness. Some implementations use a combination of attribute. For example, for a housing dataset, if the comparison utterance is “good neighborhood to buy a house”. A combination of crime rate, high school ratings, and/or high walking score, is used for the response generation. The attributes need not be a ranked list of attributes that map to an implicit attribute.

Large language models can be used in addition to, or instead of, parsing or natural language techniques. For keyword matching or fuzzy matching, large language models can sometimes identify terms in a data schema, when conventional methods cannot. Large language models also can provide structured reasoning, deeper understanding of context, when natural language parsing techniques fail, or such methods can be used in a complementary manner (instead of or in addition to large language models). The dataset described herein may be enterprise data, which are generally not available publicly, so a multi-step reasoning process is especially useful in generating data visualizations.

### Example Generation of Visualization and Text Responses

In some implementations, the visualization generation process supports a plurality of encoding channels (e.g., x, y, color) and/or a plurality of mark types (bar, line, point, circle). Some implementations include custom marks for displaying symbols in unit charts. These marks and encodings may support the dynamic generation of bar charts, line charts, scatterplots, dot plots, box plots, and unit charts that cover the range of comparisons. Some implementations select the default visualization based on the most common canonical visualization for the corresponding cardinality, as described above. Some implementations display a dynamic text summary describing the generated visualization. While template-based approaches are possible for the summary generation process, some implementations use a large language model (LLM) for generating a summary. For example, a prompt is input to the ChatGPT model. The prompt may include a data snapshot of data attributes and values relevant to interpreting the comparison utterance, e.g., ‘(comparison_utterance)’ using this list and rephrase more eloquently:\n‘$data_snapshotl\n’. For example, for the utterance, “Compare the performance of The Starling to other PG-13 movies,”, the data_snapshot comprises the IMDB movie data filtered to PG-13 movies, along with the attribute Box_office pertaining to the ambiguous token, ‘performance.’ In one instance, the generated summary is, “The box office numbers of The Starling ($23B) are lower than several PG-13 movies in the dataset. Paranoia ($410B), Dark Skies ($400B), and Grown Ups ($400B) have much higher box office numbers, while Dick Johnson is Dead has lower box office numbers ($5B) than The Starling,” where the token ‘Performance’ is interpreted as high Box_office values, as shown and described above in reference to FIG. 1B.

In some implementations, the visualization generation module takes as input SQL query results and/or generates the default visualization based on the most common canonical visualization for the corresponding cardinality. In some implementations, the system also generates a dynamic text summary describing the CoT reasoning process.

### Example Support for Repair and/or Refinement

In some implementations, the interface provides affordances for a user to change the default system choices. Some implementations support repair and/or refinement for the interpretation of ambiguous tokens. Some implementations support repair and/o refinement for switching to an alternative visualization. For example, FIG. 1B shows a drop-down menu 126-2 of attributes for the ambiguous token ‘Performance.’ A user can choose a different attribute (e.g., IMDB_rating), and the system updates the response. Similarly, FIG. 1D shows a bar chart response for an n-m type utterance. The user switches the view to a dot plot using the drop-down menu 160 to find the individual mark with the highest box office numbers.

Some implementations support combinations of attributes for resolving ambiguous tokens in the comparisons. Some implementations add additional semantic enrichment or having mechanisms for users to customize the semantics of interpreting more complex comparisons. Some implementations link relevant text phrases in the generated summary with highlighted marks in the chart to better understand the nuances in the comparison. Some implementations support additional charts (e.g., side-by-side bar charts), adding custom symbols in the unit charts, and saving user preferences for inferring comparisons could further improve the user experience exploration.

### Example Computing Device for Visual Analysis of Datasets

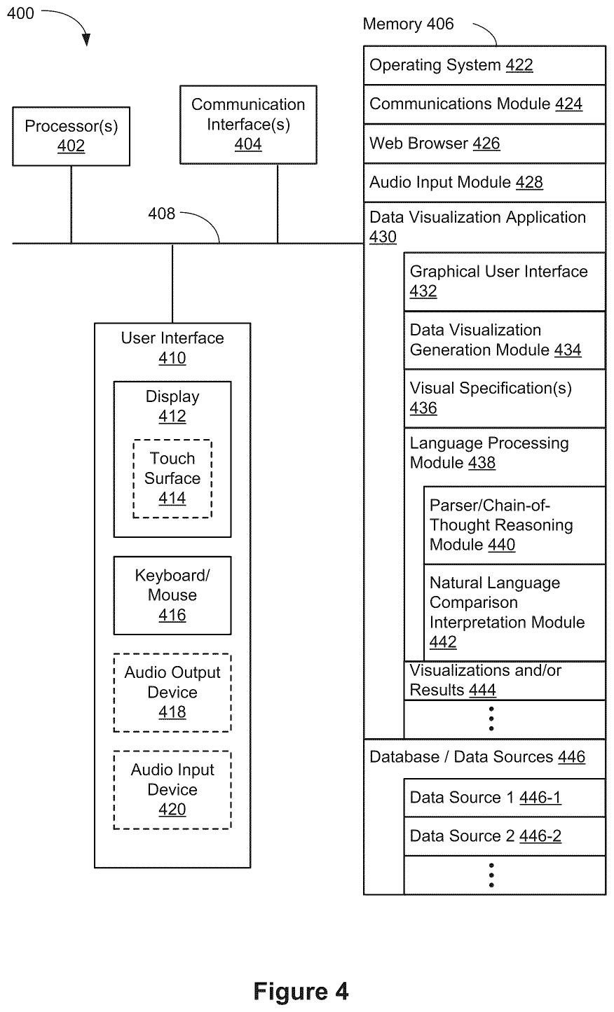

FIG. 4 is a block diagram illustrating a computing device 400, which can display the graphical user interfaces and support visual analysis of datasets, in accordance with some implementations. Various examples of the computing device 400 include a desktop computer, a laptop computer, a tablet computer, and other computing devices that have a display and a processor capable of running a data visualization application 430. The computing device 400 typically includes one or more processing units (processors or cores) 402, one or more network or other communications interfaces 404, memory 406, and one or more communication buses 408 for interconnecting these components. The communication buses 408 optionally include circuitry (sometimes called a chipset) that interconnects and controls communications between system components. The computing device 400 includes a user interface 410. The user interface 410 typically includes a display device 412. In some implementations, the computing device 400 includes input devices such as a keyboard, mouse, and/or other input buttons 416. Alternatively or in addition, in some implementations, the display device 412 includes a touch-sensitive surface 414, in which case the display device 412 is a touch-sensitive display. In some implementations, the touch-sensitive surface 414 is configured to detect various swipe gestures (e.g., continuous gestures in vertical and/or horizontal directions) and/or other gestures (e.g., single/double tap). In computing devices that have a touch-sensitive display 414, a physical keyboard is optional (e.g., a soft keyboard may be displayed when keyboard entry is needed). In some implementations, the user interface 410 also includes an audio output device 418, such as speakers or an audio output connection connected to speakers, carphones, or headphones. Furthermore, some computing devices 400 use a microphone and voice recognition to supplement or replace the keyboard. Optionally, the computing device 400 includes an audio input device 420 (e.g., a microphone) to capture audio (e.g., speech from a user).

The memory 406 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 406 includes one or more storage devices remotely located from the processor(s) 402. The memory 406, or alternately the non-volatile memory device(s) within the memory 406, includes a non-transitory computer-readable storage medium. In some implementations, the memory 406 or the computer-readable storage medium of the memory 406 stores the following programs, modules, and data structures, or a subset or superset thereof:
an operating system 422, which includes procedures for handling various basic system services and for performing hardware dependent tasks;
a communications module 424, which is used for connecting the computing device 400 to other computers and devices via the one or more communication network interfaces 404 (wired or wireless), such as the Internet, other wide area networks, local area networks, metropolitan area networks, and so on;
an optional web browser 426 (or other application capable of displaying web pages), which enables a user to communicate over a network with remote computers or devices;
an optional audio input module 428 (e.g., a microphone module) for processing audio captured by the audio input device 420. The captured audio may be sent to a remote server and/or processed by an application executing on the computing device 400 (e.g., the data visualization application 430);
a data visualization application 430 for generating data visualizations and related features. The application 430 includes a graphical user interface 432 (e.g., the graphical user interface 100 illustrated in FIGS. 1A-1D) for a user to construct visual graphics. For example, a user selects one or more data sources 446 (which may be stored on the computing device 400 or stored remotely), selects data fields from the data source(s), and/or uses the selected fields to define a visual graphic. Alternatively, or additionally, a user may select a data source 446 (sometimes referred to as a data set) (e.g., form a landing page) and/or ask a natural language question that includes a comparison query or utterance that starts the interpretation processes described herein; and
one or more databases or data sources 446 (sometimes referred to as datasets or data sets, e.g., a first data source 446-1 and a second data source 446-2), which are used by the data visualization application 430. In some implementations, the data sources are stored as spreadsheet files, CSV files, text files, JSON files, XML files, or flat files, or stored in a relational database. Examples of data sources (sometimes referred to as curated data sources or datasets) are described above.

In some implementations, the data visualization application 430 includes a data visualization generation module 434, which takes a user input (e.g., a visual specification 436), and generates a corresponding visual graphic. The data visualization application 430 then displays the generated visual graphic in the user interface 432. In some implementations, the data visualization application 430 executes as a standalone application (e.g., a desktop application). In some implementations, the data visualization application 430 executes within the web browser 426 or another application using web pages provided by a web server (e.g., a server-based application).

In some implementations, the information the user provides (e.g., user input) is stored as a visual specification 436. A visual specification includes underlying data structures that define and store the properties of a visualization. In some implementations, the visual specification includes a collection of instructions that tells the data visualization generation module 434 how to render a particular chart, graph, or dashboard based on the selected data and various configurations. The visual specification includes information about data sources and fields used in the visualization, shelf settings (e.g., dimensions, measures, filters), marks (e.g., bars, lines, shapes), visual encodings (e.g., color, size, shape), layouts and sizing, formatting and styling, calculated fields and parameters, and/or interactions and actions. In some implementations, the visual specification 436 includes natural language commands received from a user or properties specified by the user through natural language commands.

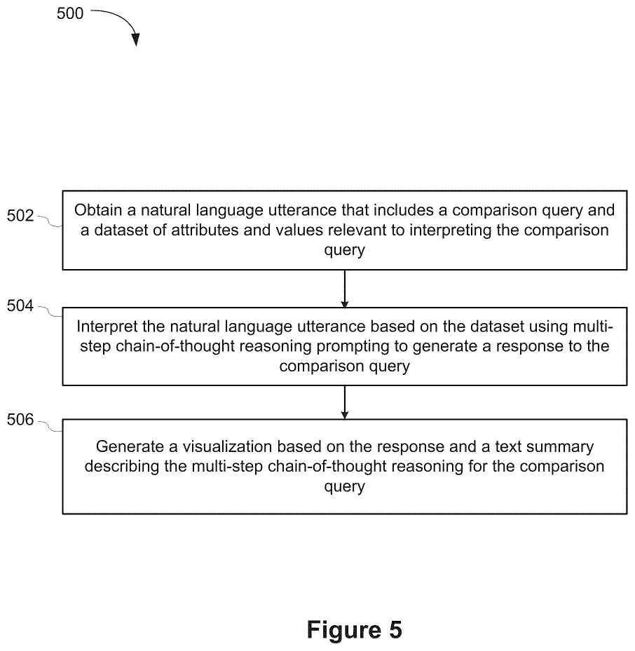

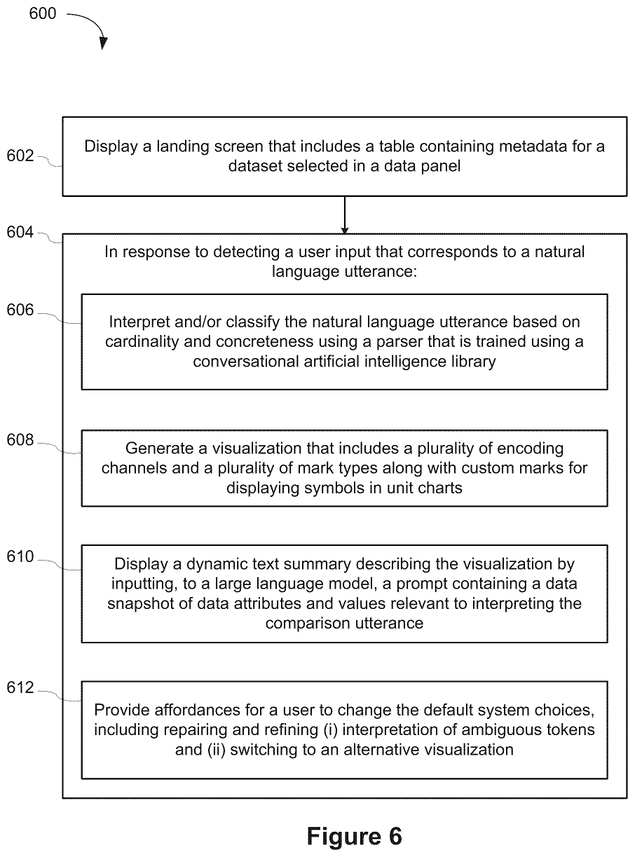

In some implementations, the data visualization application 430 includes a language processing module 438 for processing (e.g., interpreting) commands provided by a user of the computing device. In some implementations, the commands are natural language commands (e.g., captured by the audio input device 420). In some implementations, the language processing module 438 includes sub-modules, such as a parser/chain-of-thought reasoning module 440, a natural language comparison interpretation module 442, examples of which are described above in reference to FIGS. 1A-1D, 2A-2B, and 3, and further described below in reference to FIGS. 5 and 6. The data visualization application 430 also includes visualizations and/or results 444, examples of which are described above in reference to FIGS. 1A-3, according to some implementations.

In some implementations, the memory 406 stores intermediate data determined or calculated by the language processing module 438. In some implementations, the memory 406 stores prompts and/or training datasets for large language models (including models used by the parser/chain-of-thought reasoning module 440). In addition, the memory 406 may store thresholds and other criteria, which are compared against the metrics and/or scores determined by the language processing module 438.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 406 stores a subset of the modules and data structures identified above. Furthermore, the memory 406 may store additional modules or data structures not described above.

Although FIG. 4 shows a computing device 400, FIG. 4 is intended more as a functional description of the various features that may be present rather than as a structural schematic of the implementations described herein. In practice, and as recognized by those of ordinary skill in the art, items shown separately could be combined and some items could be separated.

### Example Methods for Visual Analysis of Datasets

FIG. 5 shows a flowchart of an example method 500 for interpreting natural language comparisons during visual analysis, according to some implementations. The method is performed at a computing system (e.g., one or more modules of the computing device 400) having one or more processors (e.g., the processors 402) and memory (e.g., the memory 406) storing one or more programs configured for execution by the one or more processors.

The method includes obtaining (502) (e.g., obtaining by the natural language comparison interpretation module 442; via the audio input module 428, the web browser 426, and/or the graphical user interface 432) a natural language utterance that includes a comparison query (e.g., comparison queries described above) and a dataset of attributes and values (e.g., the attributes, data types, and/or domain/range, and/or a metadata table, described above) relevant to interpreting the comparison query.

The method also includes interpreting (504) (e.g., by the parser or chain-of-thought reasoning module 440) the natural language utterance based on the dataset using multi-step chain-of-thought reasoning prompting to generate a response to the comparison query. In some implementations, the multi-step chain-of-thought reasoning prompting includes identifying relevant attributes and values by inputting a prompt containing the comparison query and a representation of the dataset to a trained large language model. In some implementations, the multi-step chain-of-thought reasoning prompting further includes inferring cardinality and concreteness of the comparison query by inputting another prompt containing the comparison query, the representation of the dataset and the relevant attributes and values to the trained large language model. In some implementations, the multi-step chain-of-thought reasoning prompting further includes: inferring a comparative analysis response by inputting yet another prompt containing the comparison query, the representation of the dataset, the relevant attributes and values, and the cardinality and concreteness, to the trained large language model; and executing a query to the dataset based on the comparative analysis response to retrieve the response to the comparison query.

The method also includes generating (506) (e.g., by the data visualization generation module 434) a visualization based on the response and a text summary describing the multi-step chain-of-thought reasoning for the comparison query. In some implementations, a data visualization is generated based on a visual specification that is based on the response and the text summary. In some implementations, generating the text summary describing the multi-step chain-of-though reasoning includes inputting prompts used for the multi-step chain-of-though reasoning and any output obtained therefrom to a trained large language model (e.g., ChatGPT, a trained model, which may be stored in, trained and/or retrained by the module 442) to obtain a text output summarizing process, input and intermediate output. In some implementations, generating the visualization includes generating a default visualization based on a most common canonical visualization for a cardinality obtained via the multi-step chain-of-thought reasoning for the comparison query. In some implementations, generating the visualization includes generating (i) unit charts for 1-1 comparisons between two items, (ii) bar charts for 1-n comparisons between one item and another set of multiple items (1-n comparisons), (iii) scatterplots for n comparisons between multiple items, and (iv) dot plots support n-m comparisons between two sets, examples of each of which are described above in reference to FIGS. 1A-1D.

In some implementations, the method further includes providing one or more affordances in a graphical user interface used for displaying the visualization, the one or more affordances allowing a user to repair or refine the interpretation of ambiguous tokens or switch to an alternative visualization, examples of which are described above at least in reference to FIG. 1B and 1C.

In some implementations, the method further includes: providing, in a graphical user interface used for displaying the visualization, a drop-down menu of attributes sorted by a probability for a token computed by the multi-step chain-of-thought reasoning prompting; and in response to a user selecting an attribute, updating an intermediate prompt used for the multi-step chain-of-thought reasoning prompting and/or updating the visualization based on the attribute. For example, FIG. 1C shows example interpretations in drop-down menus. After a user selects a different interpretation, one or more intermediate prompts described above in the section on CoT prompting is reinitialized or regenerated, and subsequently such prompts is input to a large language model to regenerate output.

In some implementations, the method further includes: providing, in a graphical user interface used for displaying the visualization, a drop-down menu of graph plot types; and in response to a user selecting a graph plot type, updating the visualization to use the graph plot type, examples of which are described above in reference to FIGS. 2A and 2B.

In some implementations, the method further includes: showing a landing screen (e.g., the landing page described above in reference to FIG. 3), in a graphical user interface used for displaying the visualization, the landing screen displaying a table containing metadata for the dataset in a data panel; in response to detecting a user input hovering over a data source thumbnail, allowing the user to view its corresponding metadata information; and detecting the natural language utterance via the graphical user interface.

FIG. 6 provides a flowchart of a process for interpreting natural language comparisons during visual analysis of a dataset, according to some implementations. The method is performed at a computing system (e.g., one or more modules of the computing device 400) having one or more processors (e.g., the processors 402) and memory (e.g., the memory 406) storing one or more programs configured for execution by the one or more processors.

The method includes displaying (602) (e.g., by the data visualization generation module 434) a landing screen that includes a table containing metadata for a dataset selected in a data panel, an example of which is described above in reference to FIG. 3.

The method also includes, in response to detecting (604) (e.g., by the language processing module 438) a user input that corresponds to a natural language utterance, interpreting and/or classifying (606) (e.g., by the parsing/chain-of-thought reasoning module 440) the natural language utterance based on cardinality and concreteness using a parser that is trained using a conversational artificial intelligence library. In some implementations, the parser is trained using templated examples of crowdsourced utterances and comparison utterances. In some implementations, the templates include slots for attributes and values. In some implementations, a set of data sources is specified during the training of the parser. In some implementations, the parser handles imprecision including misspellings and incomplete input by applying fuzzy matching and lammatization on input tokens with attributes in the datasets. In some implementations, the method further includes augmenting the datasets with additional metadata and semantics that helps with understanding and interpretation of the utterances, such as related ontological concepts, including synonyms and related terms.

The method also includes generating (608) (e.g., by the data visualization generation module 434) a visualization that includes a plurality of encoding channels (e.g., x, y, color) and a plurality of mark types (e.g., bar, line, point, circle) along with custom marks for displaying symbols in unit charts. In some implementations, the marks and encodings support dynamic generation of bar charts, line charts, scatterplots, dot plots, box plots, and unit charts that cover the range of comparisons. In some implementations, generating the visualization includes selecting a default visualization based on common canonical visualization for the corresponding cardinality, examples of which are described above in reference to FIGS. 1A-1D.

The method also includes displaying (610) a dynamic text summary describing the visualization by inputting, to a large language model, a prompt containing a data snapshot of data attributes and values relevant to interpreting the comparison utterance.

The method also includes providing affordances (612) for a user to change the default system choices, including repairing and refining (i) interpretation of ambiguous tokens (e.g., a drop-down menu of attributes for ambiguous tokens) and (ii) switching to an alternative visualization (e.g., a drop-down menu to switch from a bar chart to a dot plot). Examples of these operations and drop-down menus are described above.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of interpreting natural language comparisons during visual analysis, comprising:
at a computing system having one or more processors and memory storing one or more programs configured for execution by the one or more processors:
obtaining a natural language utterance that includes a comparison query and a dataset of attributes and values relevant to interpreting the comparison query;
interpreting the natural language utterance based on the dataset using multi-step chain-of-thought reasoning prompting to generate a response to the comparison query; and
generating a visualization based on the response and a text summary describing the multi-step chain-of-thought reasoning for the comparison query.

2. The method of claim 1, wherein the multi-step chain-of-thought reasoning prompting comprises identifying relevant attributes and values by inputting a prompt containing the comparison query and a representation of the dataset to a trained large language model.

3. The method of claim 2, wherein the multi-step chain-of-thought reasoning prompting further comprises inferring cardinality and concreteness of the comparison query by inputting another prompt containing the comparison query, the representation of the dataset and the relevant attributes and values to the trained large language model.

4. The method of claim 3, wherein the multi-step chain-of-thought reasoning prompting further comprises:
inferring a comparative analysis response by inputting yet another prompt containing the comparison query, the representation of the dataset, the relevant attributes and values, and the cardinality and concreteness, to the trained large language model; and
executing a query to the dataset based on the comparative analysis response to retrieve the response to the comparison query.

5. The method of claim 1, wherein generating the text summary describing the multi-step chain-of-though reasoning comprises inputting prompts used for the multi-step chain-of-though reasoning and any output obtained therefrom to a trained large language model to obtain a text output summarizing process, input and intermediate output.

6. The method of claim 1, wherein generating the visualization comprises generating a default visualization based on a most common canonical visualization for a cardinality obtained via the multi-step chain-of-thought reasoning for the comparison query.

7. The method of claim 1, further comprising providing one or more affordances in a graphical user interface used for displaying the visualization, the one or more affordances allowing a user to repair or refine the interpretation of ambiguous tokens or switch to an alternative visualization.

8. The method of claim 1, further comprising:
providing, in a graphical user interface used for displaying the visualization, a drop-down menu of attributes sorted by a probability for a token computed by the multi-step chain-of-thought reasoning prompting; and
in response to a user selecting an attribute, updating an intermediate prompt used for the multi-step chain-of-thought reasoning prompting and/or updating the visualization based on the attribute.

9. The method of claim 1, further comprising:
providing, in a graphical user interface used for displaying the visualization, a drop-down menu of graph plot types; and
in response to a user selecting a graph plot type, updating the visualization to use the graph plot type.

10. The method of claim 1, further comprising:
showing a landing screen, in a graphical user interface used for displaying the visualization, the landing screen displaying a table containing metadata for the dataset in a data panel;
in response to detecting a user input hovering over a data source thumbnail, allowing the user to view its corresponding metadata information; and
detecting the natural language utterance via the graphical user interface.

11. The method of claim 1, wherein generating the visualization comprises:
generating (i) unit charts for 1-1 comparisons between two items, (ii) bar charts for comparisons between one item and another set of multiple items (1-n comparisons), (iii) scatterplots for comparisons between multiple items (n comparisons), and (iv) dot plots support n-m comparisons between two sets.

12. A computer system for visual analysis of datasets, comprising:
one or more processors; and
memory;
wherein the memory stores one or more programs configured for execution by the one or more processors, and the one or more programs comprising instructions for:
obtaining a natural language utterance that includes a comparison query and a dataset of attributes and values relevant to interpreting the comparison query;
interpreting the natural language utterance based on the dataset, using multi-step chain-of-thought reasoning prompting, to generate a response to the comparison query; and
generating a visualization based on the response and a text summary describing the multi-step chain-of-thought reasoning for the comparison query.

13. The computer system of claim 12, wherein the multi-step chain-of-thought reasoning prompting comprises identifying relevant attributes and values by inputting a prompt containing the comparison query and a representation of the dataset to a trained large language model.

14. The computer system of claim 13, wherein the multi-step chain-of-thought reasoning prompting further comprises inferring cardinality and concreteness of the comparison query by inputting another prompt containing the comparison query, the representation of the dataset and the relevant attributes and values to the trained large language model.

15. The computer system of claim 14, wherein the multi-step chain-of-thought reasoning prompting further comprises:
inferring a comparative analysis response by inputting yet another prompt containing the comparison query, the representation of the dataset, the relevant attributes and values, and the cardinality and concreteness, to the trained large language model; and
executing a query to the dataset based on the comparative analysis response to retrieve the response to the comparison query.

16. The computer system of claim 12, wherein generating the text summary describing the multi-step chain-of-though reasoning comprises inputting prompts used for the multi-step chain-of-though reasoning and any output obtained therefrom to a trained large language model to obtain a text output summarizing process, input and intermediate output.

17. The computer system of claim 12, wherein generating the visualization comprises generating a default visualization based on a most common canonical visualization for a cardinality obtained via the multi-step chain-of-thought reasoning for the comparison query.

18. The computer system of claim 12, further comprising providing one or more affordances in a graphical user interface used for displaying the visualization, the one or more affordances allowing a user to repair or refine the interpretation of ambiguous tokens or switch to an alternative visualization.

19. The computer system of claim 12, further comprising:
providing, in a graphical user interface used for displaying the visualization, a drop-down menu of attributes sorted by a probability for a token computed by the multi-step chain-of-thought reasoning prompting; and
in response to a user selecting an attribute, updating an intermediate prompt used for the multi-step chain-of-thought reasoning prompting and/or updating the visualization based on the attribute.

20. A non-transitory computer readable storage medium storing one or more programs configured for execution by a computer system having a display, one or more processors, and memory, the one or more programs comprising instructions for:
obtaining a natural language utterance that includes a comparison query and a dataset of attributes and values relevant to interpreting the comparison query;
interpreting the natural language utterance, based on the dataset, using multi-step chain-of-thought reasoning prompting, to generate a response to the comparison query; and
generating a visualization based on the response and a text summary describing the multi-step chain-of-thought reasoning for the comparison query.
